(19) United States
(12) Patent Application Publication
(10) Pub. No.: US 2004/0079741 A1
(43) Pub. Date: Apr. 29, 2004

(54) Apparatus and method for protecting a welding implement contact tip

(76) Inventor: James M. Keegan, Troy, OH (US)

Correspondence Address: Patrick S. Yoder, Fletcher, Yoder & Van Someren, P.O. Box 692289, Houston, TX, 77269-2289, US

(21) Appl. No.: 10/280,478

(22) Filed: Oct. 24, 2002

(51) Int. Cl. B23K 9/28

(52) U.S. Cl. 219/137.61

(57) ABSTRACT

According to one aspect of the present technique a novel ceramic contact tip extension is featured. The ceramic extension may comprise a zirconium-based material. According to another aspect of the present invention, a novel wire-feed welding system is featured. The welding system may feature an electrical power source, a wire-feeder having a wire electrically coupleable to the electric power source, and a welding implement adapted to receive a tubular metal wire from the wire-feeder. The welding implement has a contact tip and a contact tip extension. According to yet another aspect of the present technique, a method for protecting a contact tip is feature. The method comprises thermally insulating the contact tip.

### FIELD OF THE INVENTION

The present invention relates generally to welding systems, and particularly to a wire-feed welding implement having a thermal insulator to protect a contact tip.

### BACKGROUND OF THE INVENTION

Welding is a method that may be used to either join pieces of metal or separate them apart. An exemplary type of welding process is arc welding. An arc welding system typically comprises an electrical power source coupled to a welding implement. An electrode is routed through the welding implement and is electrically coupled to the electrical power source. Additionally, a conductive cable is clamped to a work piece and routed back to the electrical source. An electric arc is produced between the electrode and the work piece when the electrode is brought into close proximity to, or in contact with, the work piece. The electric current flows from the power source through the electrode to the work piece and back to the electrical power source through the conductive cable. The heat produced by the arc melts the work piece, or work pieces. The molten metal cools once the arc is removed, causing the molten material to solidify.

One exemplary type of arc welding system is Metal Inert Gas (MIG) welding. MIG welding is also known as “wire-feed” or Gas Metal Arc Welding (GMAW). In MIG welding the wire serves as the electrode. The wire, supplied by a wire-feeder, is routed through a welding cable connected to the power source at one end and a welding implement at the other end. Typically, the welding implement has a contact tip that is electrically coupled to the welding cable. As the wire passes through the contact tip, electric current flows through the welding cable and contact tip into the electrode wire. Typically, the heat generated by the arc melts the electrode wire, creating a filler material that combines with the molten metal. To prevent impurities and contaminants from entering the molten metal, an inert gas is used to form a shield around the molten metal. The inert gas is typically routed through the welding implement along with the electrode wire. By depressing a trigger on the welding implement, a user may be able to simultaneously activate the wire-feeder and the inert gas stream.

In non-shielded MIG welding, the choice of electrode wire eliminates the need for the shielding gas. In this type of welding, a tubular metal electrode wire is used. The tubular wire has a flux disposed on the inside, preventing chipping and flaking. A tubular metal electrode wire typically is capable of welding thicker metals at higher voltage and amperage settings than comparable solid wire, such as used with an inert gas.

Another form of arc welding is known as submerged arc welding. In contrast to the inert gas employed in MIG welding, submerged arc welding uses a granular flux to protect the weld puddle. As a user progresses the welding implement, granular flux is deposited ahead of the electrode so that the arc is submerged within the layer of flux. The molten weld puddle is thereby protected from impurities and contaminants by the surrounding flux. Moreover, the flux located adjacent to the arc provides a slag layer that refines the weld and excludes air.

In typical MIG and submerged arc systems, the contact tip is formed from copper, or a copper alloy. However, these contact tips have been known to fail after a relatively short period of use, especially when tubular electrode wire is used. There exists a need for a technique for increasing the life of contact tips of welding implements. More specifically, there exists a need for a method of increasing the lifetime of contact tips used with tubular electrode wire, as well as in submerged arc welding applications.

### SUMMARY OF THE INVENTION

The present technique may solve one or more of the problems outlined above. According to one aspect of the present technique a novel ceramic contact tip extension is featured. The ceramic extension may comprise a zirconium-based material, such as zironium silicate or zirconia.

According to another aspect of the present invention, a novel wire-feed welding system is featured. The welding system may comprise an electrical power source, a wire-feeder, and a welding implement adapted to receive a tubular metal electrode wire from the wire-feeder. The welding implement has a ceramic contact tip extension attached to the contact tip that works in conjunction with the tubular metal electrode wire.

According to yet another aspect of the present technique, a method for protecting a contact tip is feature. The method comprises the step of thermally insulating a portion of a contact tip.

### BRIEF DESCRIPTION OF THE DRAWINGS

The foregoing and other advantages and features of the invention will become apparent upon reading the following detailed description and upon reference to the drawings in which:

FIG. 1 is a diagram of a MIG welding system, according to an exemplary embodiment of the present technique;

FIG. 2 is a front elevation view of a MIG welding gun, according to an exemplary embodiment of the present technique;

FIG. 3 is an exploded view of the MIG welding gun of FIG. 2;

FIG. 4 is a perspective view an exemplary embodiment of a contact tip and contact tip extension;

FIG. 5 is a cross-sectional view of the exemplary contact tip and ceramic contact tip extension shown in FIG. 4;

FIG. 6 is a diagram of a submerged arc welding system, according to an exemplary embodiment of the present technique;

FIG. 7 is a front elevation view of a submerged arc welding gun, according to an exemplary embodiment of the present technique; and

FIG. 8 is an exploded view of the submerged arc welding gun of FIG. 7.

### DETAILED DESCRIPTION OF SPECIFIC EMBODIMENTS

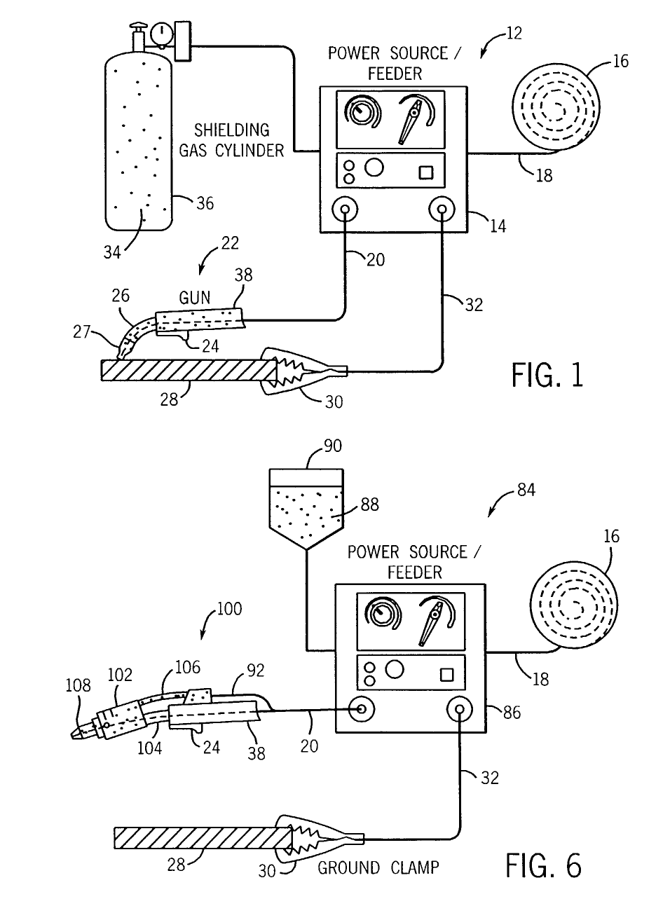

Referring generally to FIG. 1, this figure depicts an exemplary portable MIG arc welding system 12. However, the present techniques are applicable to other types of arc welding systems, such as fixed systems and submerged arc welding systems. The illustrated embodiment includes a power source/wire feeder 14 having a wire spool 16. The power source/wire feeder 14 accepts an electrode wire 18 from the wire spool 16 and directs the electrode wire 18 into a welding cable 20 of a welding gun 22. However, the present techniques are applicable to welding implements other than a welding gun, such as a robotic welder.

In the illustrated embodiment, the electrode wire 18 is tubular and comprised of metal. A granular flux may be disposed within the tubular metal electrode wire 18. The welding cable 20 has conductors for transmitting power from the power source/wire feeder 14 to a welding gun 22. In this embodiment, the power source and wire feeder are combined. However, the power source and wire feeder also may be provided as separate devices.

The welding gun is adapted to receive the electrode wire 18 and couple the electric power from the conductors in the welding cable 20 to the electrode wire 18. In addition, the welding gun 22 is adapted to control operation of the welding system 12. In this embodiment, the welding gun 22 has a trigger 24 that is electrically coupled by the welding cable 20 to the power source/wire feeder 14. In this embodiment, the electrode wire 18 is advanced from the power source/wire feeder 14 when the trigger 24 is operated. The wire 18 is guided through the welding cable 20 to the neck 26 of the welding gun 22.

A work piece 28 is electrically coupled to one terminal of the power source/wire feeder 14 by a ground clamp 30 and a ground cable 32. An electrical circuit between the work piece 28 and power source/wire feeder 14 is completed when the electrode wire 18 is placed in proximity to, or in contact with, the work piece 28, producing an arc between the wire 18 and the work piece 28. The heat produced by the electric current flowing into the work piece 28 through the arc causes the work piece 28 to melt in the vicinity of the arc, also melting the electrode wire 18. In the illustrated embodiment, gas 34 stored in a gas cylinder 36 is used to shield the molten weld puddle from impurities. However, other methods of providing a shield gas also may be utilized.

In the illustrated embodiment, the gas cylinder 36 feeds gas 34 to the power source/wire feeder 14. The gas 34 is fed, along with the electrode wire 18, through the welding cable 20 to the neck 26 of the welding gun 22. The neck 26 has a nozzle assembly 27 to direct gas 34 towards the work piece 28. The trigger 24 also may control the flow of gas 34 from the welding gun 22. However, the flow of gas 34 may be controlled by other methods, such as a valve. The inert shield gas 34 prevents impurities entering the weld puddle and degrading the integrity of the weld.

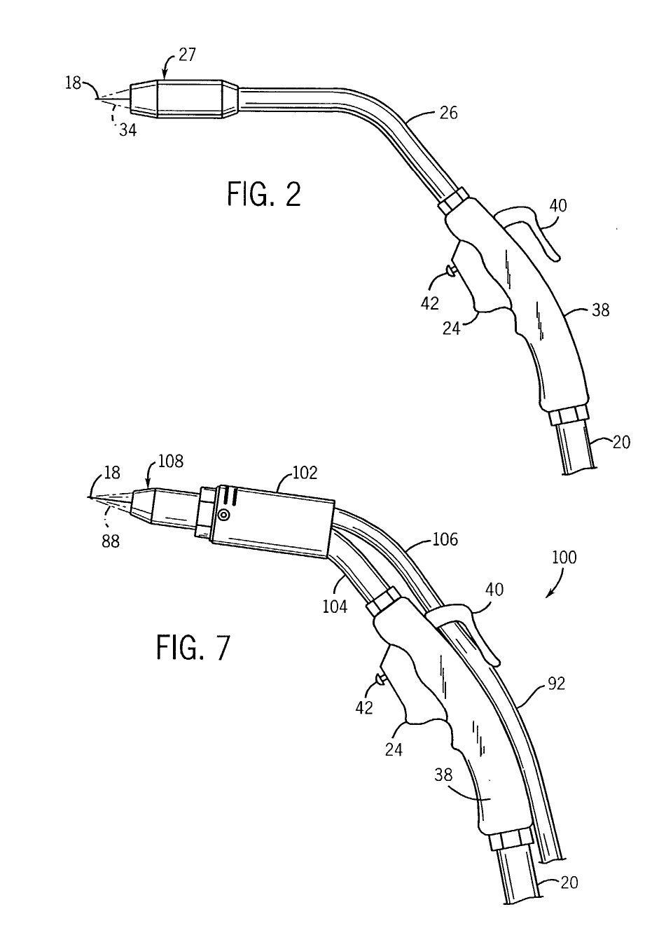

Referring generally to FIG. 2, a more detailed illustration of the welding gun 22 is provided. As discussed above, the welding gun 22 is employed to receive electrode wire 18 and gas 34 from the welding cable 20 and direct them toward the work piece 28. The welding gun 22 comprises a handle 38 that may be used to hold the welding gun 22. In the illustrated embodiment, a mounting hook 40 is provided to enable the welding gun 22 to be hung from a fixture. The illustrated welding gun also has a trigger 24. The trigger 24 may be biased to deactivate the welding system when released. A trigger lock 42 is provided in this embodiment so as to relieve the user from the task of maintaining constant pressure on the trigger 24.

In this embodiment, electrode wire 18 is directed from the welding cable 20 into the neck 26. The neck 26 guides the gas 34 and electrode wire 18 to the nozzle assembly 27. The nozzle assembly 27, in turn, directs the gas 34 and wire 18 towards the work piece 28. The nozzle assembly 27 is adapted to direct the gas 34 to form a barrier to prevent contaminants from entering the molten weld puddle produced by the arc from the electrode wire 18.

Referring generally to FIG. 3, an exploded view of the welding gun 22 is illustrated. In the illustrated embodiment, the handle 38 is a two-piece assembly adapted to receive the welding cable 20 within the interior of the handle 38. Also attached to the welding cable 20 is a pair of conductors 44. In this embodiment, the conductors 44 are routed into the interior of the handle 38 so that the conductors 44 may be coupled to the trigger 24. In this embodiment, the conductors 44 are electrically coupled when the trigger 24 is depressed. Electrically coupling the conductors 44 provides a signal to the power source/wire feeder 14 to advance the electrode wire 18. The signal may also direct the power source/wire feeder 14 to apply power to the welding cable 20 and/or provide a flow of gas 34 from the gas cylinder 36. In the illustrated embodiment, the two sides of the handle 38 are secured together by a screw 46 and a nut 48.

In this embodiment, electrical power from the power source/wire feeder 14 is conducted to the electrode wire 18 by a contact tip 50. The electricity is coupled through the welding cable 20 and the neck 26 to the contact tip 50. In this embodiment, the contact tip 50 is maintained in abutment against the neck 26 by a nut 52. However, other methods of securing the contact tip 50 may be utilized. For example, the contact tip 50 may be threaded into The nut 52 is disposed around a collar 54 of the contact tip 50 and threads onto threads 56 located on the neck 26. The engagement between the nut 52 and the threads 56 urges the contact tip collar 54 into abutment against the neck 26, thereby securing the contact tip 50 to the welding gun. The contact tip 50 may also abut another member within the nozzle assembly 27.

The contact tip 50 is comprised of a conductive metal, such as copper. It has been found that contact tips are heated not only by the electrical current flowing through the contact tip, but by heat transferred to the contact tip from the electrode wire and from the weld puddle. This heat shortens the lifetime of the contact tip. As the contact tips temperature increases, it becomes more malleable and prone to wear. The electrical resistance of the material affects the heat produced by the electrical current. For the same current, the material having the greater resistance will produce the greater heat. The electrical resistance of an electrode wire typically is greater than the electrical resistance of the contact tip, thereby causing significant resistive heating of the wire during operation.

In addition, it has been found that the lifetime of contact tips in welding systems using tubular electrode wire is much shorter than that of solid electrode wire. It has also been found that a factor in the shorter lifetime of these contact tips is the heat produced by current flowing through the tubular electrode. For the same diameter, the electrical resistance of tubular electrode wire, even with a metallic powder core, is greater than that of solid electrode wire because the electrical current only flows primarily through the tubular portion of the wire. This greater electrical resistance causes the tubular metal electrode wire to heat up to a higher temperature faster and, therefore, to melt more quickly than solid wire. This heating of the tubular electrode wire enables the tubular electrode wire to produce greater deposition rates than solid electrode wire for the same current. However, it has been found that the heat produced by the tubular electrode wire also results in a shorter lifetime of the contact tip.

In the illustrated embodiment, a contact tip extension 58 is used to thermally insulate the contact tip 50 from the weld puddle and the tubular electrode wire beyond the contact tip 50, thereby reducing the heat transferred to the contact tip 50. The contact tip extension 58 also increases the distance between the contact tip 50 and the weld puddle, also reducing the heat transferred to the contact tip 50. In this embodiment, the contact tip extension 58 is comprised of a ceramic material. Preferably, the contact tip extension 58 is comprised of a zirconium based ceramic, such as zirconia or zirconium silicate. The hardness of zirconium silicate provides the contact tip extension 58 with desirable wear characteristics, so that it does not easily erode, chip, and/or flake. The contact tip 50 and contact tip extension 58 are housed within the nozzle assembly 27.

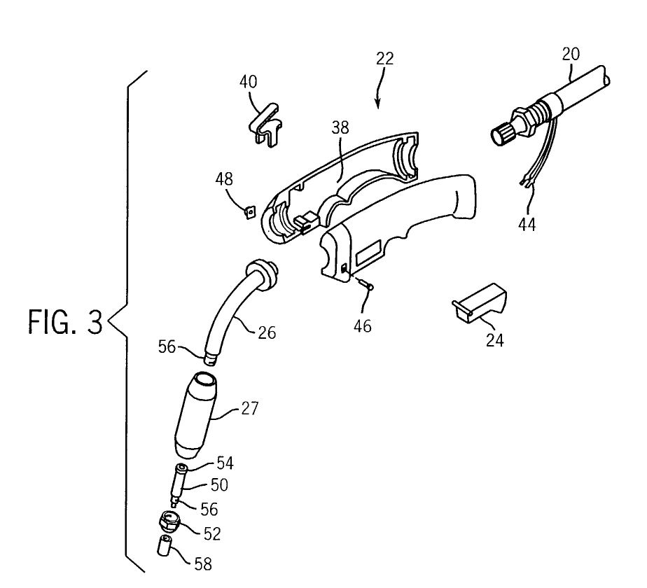

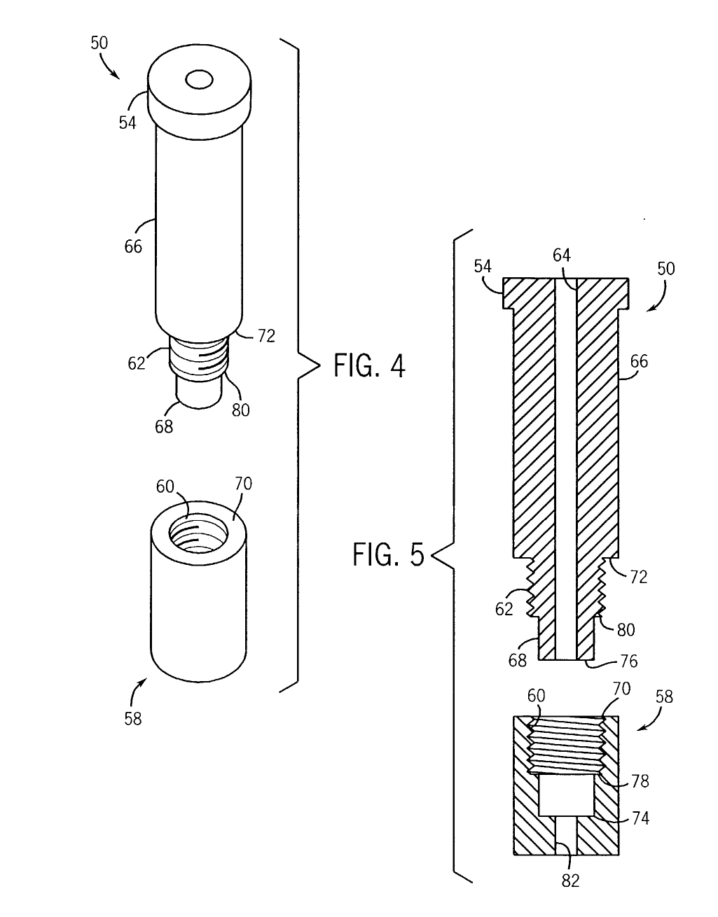

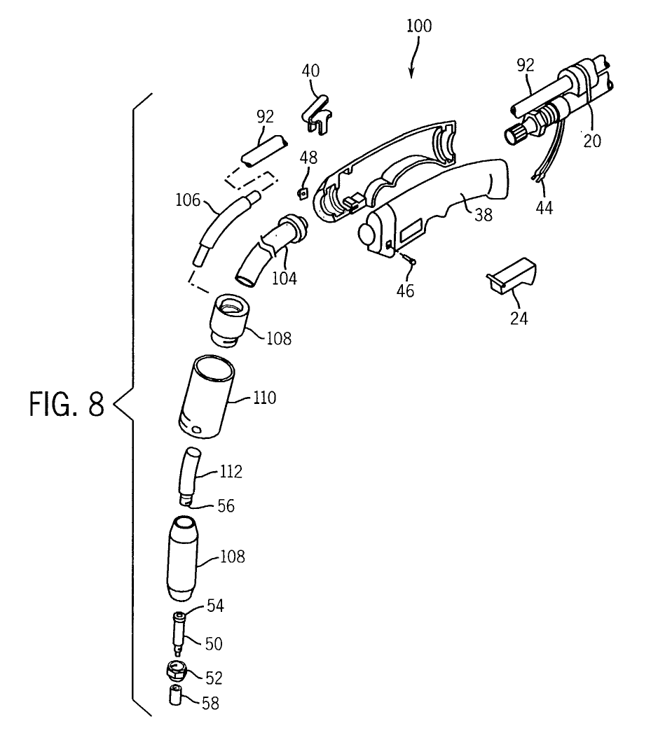

Referring generally to FIGS. 4 and 5, in this embodiment, the contact tip extension 58 has threads 60 that are adapted to enable the contact tip extension 58 to thread onto corresponding threads 62 on the contact tip 50. However, the contact tip extension 58 may be secured to the contact tip 50 by other methods, such as bonding, depositing, or molding, etc. The metallic contact tip 50 receives the electrode wire 18 through a channel 64. In this embodiment, the diameter of the channel 64 is slightly larger than the diameter of the electrode wire 18. The electrode wire 18 will contact the sides of the channel 64 as the electrode wire 18 passes through the contact tip 50, thereby enabling electric current to be conducted from the contact tip 50 to the electrode wire 18. In this embodiment, the contact tip 50 has a cylindrical main body portion 66 having a diameter slightly less than the diameter of the collar 54. The illustrated contact tip 50 has an end portion 68, which has a slightly smaller diameter than the threaded portion 62 of the contact tip 50. The end portion 68 is adapted to guide the contact tip extension 58 onto the contact tip 50.

As illustrated in FIG. 5, the top surface 70 of the contact tip extension 58 and a shoulder 72 of the contact tip 50 are adapted to abut. In addition, in this embodiment, a first surface 74 within the contact tip extension 58 is adapted to abut the bottom surface 76 of the contact tip 50. A second surface 78 within the contact tip extension 58 is adapted to abut a corresponding surface 80 of the contact tip 50. In addition, the contact tip extension 58 has a channel 82 for the electrode wire 18 to pass therethrough. Preferably, the contact tip extension channel 82 and the contact tip channel 64 form a continuous channel.

Referring generally to FIG. 6, an exemplary submerged arc welding system 84 is illustrated. As in MIG welding, an arc is created between electrode wire 18 and work piece 28 to create a weld in submerged arc welding. However, in submerged arc welding, the arc is submerged within flux to shield the molten weld puddle from absorbing impurities. In the illustrated embodiment, a power source/wire feeder 86 adapted to accept flux 88 from a flux source 90 is used to transmit flux 88 through a hose 92 to a submerged arc welding gun 100. In other embodiments of the present technique, the flux hose 92 may be connected directly to the flux source 90.

Referring generally to FIGS. 6 and 7, the illustrated submerged arc welding gun 100 has a flux distribution assembly 102 adapted to direct wire 18 and flux 88 towards a work piece 28. The flux distribution assembly 102 receives electrode wire 18 via a neck 104 and flux 88 via a flux neck 106 coupled to the flux hose 92. The flux distribution assembly 102 merges the flow of electrode wire 18 and flux 88. The wire 18 and flux 88 flow out of the flux distribution assembly 102 through a nozzle assembly 108, thereby submerging the resultant arc produced by the electrode wire 18 in flux 88. Flux 88 disposed proximate to the weld puddle is heated to a molten state and is incorporated into the weld. The unused flux may be recycled.

Referring generally to FIG. 7, the flux distributor assembly comprises a flux distributor 108 and a shell 110 surrounding the flux distributor 108. In this embodiment, the flux hose 92 is routed on the exterior of the handle 38. The flux hose 92 mates with the flux neck 106, which is mated with the flux distributor 108. The flux distributor 108 directs the flow of the flux 88 such that the electrode wire 18 is fully submerged within the flux 88 at the point the arc strikes the work piece 28.

In this embodiment, the submerged arc welding gun 100 electrical couples power to the electrode wire 18 through contact tip 50. In this embodiment, contact tip 50 is maintained in abutment against a neck 112 by a nut 52. However, other methods of securing the contact tip 50 may be utilized. The nut 52 is disposed around a collar 54 of the contact tip 50 and threads onto threads 56 located on the neck 112. The engagement between the nut 52 and the threads 56 urges the contact tip collar 54 into abutment against the neck 112, thereby securing the contact tip 50 to the welding gun. The contact tip 50 may also abut another member within the submerged arc welding gun 100.

As with the MIG welding gun 22 discussed above, the illustrated submerged arc welding gun 100 utilizes a contact tip extension 58 to increase the distance between the contact tip 50 and the molten weld puddle and to thermally insulate the contact tip 50, thereby reducing the heat transferred to the contact tip 50 from the molten weld puddle of the work piece 28.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. An apparatus for protecting a contact tip of a wire-feed welding system, comprising:
a contact tip extension securable to the contact tip, the contact tip extension having a channel adapted to receive an electrode wire therethrough, wherein the extension member comprises zirconium.

2. The apparatus of claim 1, wherein the contact tip extension is adapted to guide an electrode wire through the channel.

3. The apparatus of claim 1, wherein the contact tip extension is removably securable to a first end of the contact tip.

4. The apparatus of claim 3, wherein the contact tip and the contact tip extension are complementarily threaded.

5. The apparatus of claim 3, wherein the contact tip extension comprises a shoulder adapted to abut against a corresponding shoulder of the contact tip.

6. The apparatus of claim 3, wherein the contact tip extension is adapted to thermally insulate the first end of the contact tip.

7. The apparatus of claim 1, wherein the contact tip extension comprises zirconium silicate.

8. The apparatus of claim 1, wherein the contact tip extension comprises zirconia.

9. A wire-feed arc welding system comprising:
a welding implement adapted to electrically couple a tubular metal wire to a power supply, comprising:
a contact tip adapted to conduct electricity to the tubular metal wire; and
a contact tip extension removably secured to the contact tip, wherein the contact tip extension is adapted to receive the tubular metal electrode therethrough.

10. The arc welding system of clam 9, wherein the contact tip extension comprises zirconium.

11. The arc welding system of clam 10, wherein the contact tip extension comprises zirconia.

12. The arc welding system of clam 10, wherein the contact tip extension comprises zirconium silicate.

13. The arc welding system of claim 9, wherein the tubular metal wire comprises flux disposed therein.

14. The arc welding system of claim 9, wherein the contact tip extension is adapted to guide the tubular metal wire through the contact tip extension.

15. A kit for a wire-feed welding implement, comprising:
a contact tip adapted to electrically couple a power source to an electrode wire disposed through the contact tip; and
a zirconium-based material disposed on a portion of the contact tip.

16. The kit as recited in claim 15, wherein the zirconium-based material comprises zirconia.

17. The kit as recited in claim 15, comprising an extension secured to the contact tip, wherein the extension comprises zirconium silicate.

18. A submerged arc welding system comprising:
a submerged arc welding implement adapted to direct movement of electrode wire and flux, comprising:
a nozzle assembly adapted to direct the flow of flux;
a contact tip disposed within the nozzle assembly and adapted to couple electricity to the electrode wire; and
a ceramic contact tip extension secured to the contact tip.

19. The system of claim 18, wherein the electrode wire is tubular.

20. The system of claim 18, wherein the ceramic contact tip comprises zirconium.

21. The system of claim 20, wherein the ceramic contact tip extension comprises zirconium silicate.

22. The system of claim 20, wherein the ceramic contact tip extension comprises zirconia.

23. A method of protecting a contact tip of an arc welding system, comprising the acts of:
thermally insulating at least a portion of the contact tip to reduce heat being transferred into the contact tip from an exterior location.

24. The method of claim 23, wherein thermally insulating comprises securing a zirconium silicate contact tip extension to the contact tip.

25. The method of claim 24, comprising the act of feeding an electrode wire through the contact tip and contact tip extension.

26. The method of claim 25, wherein feeding comprises feeding a tubular electrode wire through the contact tip and contact tip extension.

27. A system for protecting a contact tip of an arc welding implement, comprising:
a contact tip adapted to conduct electricity to an electrode wire disposed therethrough; and
a ceramic material disposed on a first portion of the contact tip to thermally insulate the contact tip from heat produced exterior of the arc welding implement.

28. The system of claim 27, wherein the ceramic material comprises an extension member secured to the contact tip.

29. The system of claim 28, wherein the ceramic material comprises zirconium.

30. The system of claim 29, wherein the extension member comprises zirconium silicate.

31. The system of claim 29, wherein the extension member comprises zirconia.

32. The system of claim 27, wherein the first portion comprises an end of the contact tip.

33. The system of claim 32, wherein the ceramic material comprises zirconium.

34. The system of claim 33, wherein the ceramic material comprises zirconium silicate.

35. The system of claim 33, wherein the ceramic material comprises zirconia.

36. A method of operating a submerged arc welding system, comprising the acts of:
routing a tubular metal wire through a contact tip; and
applying a thermal insulator to the contact tip to prevent at least a portion of the heat generated in the tubular metal wire by resistive heating from being transfered to the contact tip.

37. The method of claim 36, wherein applying a thermal insulator comprises securing a zirconium silicate contact tip extension to the contact tip.
